(19) United States
(12) Patent Application Publication
(10) Pub. No.: US 2013/0055410 A1
(43) Pub. Date: Feb. 28, 2013

(54) METHOD OF ACCESSING DIGITAL MEDIA CONTENT

(71) Applicants: Mark Knight, London (GB); Philip Sant, London (GB); John Richards, London (GB); Robert John Lewis, London (GB); Stephen William Pocock, London (GB); Christopher John Evans, London (GB)

(72) Inventors: Mark Knight, London (GB); Philip Sant, London (GB); John Richards, London (GB); Robert John Lewis, London (GB); Stephen William Pocock, London (GB); Christopher John Evans, London (GB)

(73) Assignee: Omnifone Ltd., London (GB)

(21) Appl. No.: 13/581,044

(22) PCT Filed: Feb. 28, 2011
(86) PCT No.: PCT/GB2011/050391

§ 371 Date: Nov. 13, 2012

(30) Foreign Application Priority Data
Feb. 26, 2010 (GB) 1003296.9

(51) Int. Cl. G06F 21/00

(52) U.S. Cl. 726/28

(57) ABSTRACT

The invention permits a user to be given access to digital media content on one set of conditions, for a limited time period made known to the consumer, but then automatically forces migration to a different set of conditions to retain access to digital media content already listened to and to gain access to new digital media content, without the consumer having to manually download or install new software or in some other manner interact in a manner that will lessen the chance of the consumer embracing or accepting the migration.

### BACKGROUND OF THE INVENTION

1. Field of the Invention

This invention relates to a method of accessing digital media content. The digital media content is typically held in a digital media catalogue stored on a server computing device. A user may access the server over a wide area network (which may be a wireless WAN such as a cellular network, or a wire-based network, or a combination) from a client device such as a mobile telephone, PC, television, set top box, in-car infotainement system or any other kind of computing device. The digital media content may also be held locally on the user's device.

2. Description of the Prior Art

A number of different models have historically been used to provide subscription-based access to digital media. Such models include payment for individual music tracks; payment for groups of music tracks, such as collections or bundles; recurring payment for access to a digital media catalogue; recurring payment for limited access to a digital media catalogue; free trial access to a digital media catalogue; access to a digital media catalogue where the said access is subsidized by advertising revenue; access to a digital media catalogue where the license is sold inclusive of the price of a particular device.

All such models have historically had a common factor, in that once the conditions have been set under which a user may access a digital media catalogue then those conditions have been fixed unless and until the user manually migrates to a different set of conditions. The manual initiation of the migration by the consumer is done at substantially the time and as part of the migration process; hence, the migration might involve moving from a ‘free’ service to a ‘premium’ paid-for service and then the manual initiation of the migration would involve the consumer explicitly selecting to use the ‘premium’ service, for example by selecting an option displayed in a client-side application.

Automatically altering the conditions allowing a consumer continued access to digital media content, including content already played/listened to and perhaps stored on a local playlist, is not done. That is because the mindset of the engineers designing the system has been that, once a user has been given access to that digital media content on one set of conditions (e.g. operating system type or version, media player type or version, browser type or version, make of media player, security settings, tariff level etc. etc.) then the user cannot be forced to migrate to a different set of conditions to retain access to digital media content already listened to and/or to gain access to new digital media content.

There have been controversies in the past when changes to conditions have occurred, in effect blocking consumers from accessing digital media content already listened to and preventing them from gaining access to new digital media content. For example, digital media files purchased from one store have proven incompatible with files purchased from another, due to the use of incompatible DRM protection mechanisms. And even within a single application, changes to the DRM system has blocked users from accessing digital media content which has been downloaded via the previous version of that application.

As a consequence, the mindset of system designers is that altering the conditions allowing a consumer continued access to digital media content should not be done.

This approach underlies the ubiquitous practice of ensuring broad backward compatibility with old operating systems etc. It also underlies the practice of—when offering both free services, perhaps supported by advertising, and an enhanced premium service—making it entirely down to the user to migrate from the free to the premium, subscription based service. Conversion rates to subscription based premium services are inevitably quite low, not least because many consumers habituate to the lower quality experience of the free service.

The present invention challenges that orthodox viewpoint. It permits a user to be given access to digital media content on one set of conditions, for a limited time period made known to the consumer, but then automatically forces migration to a different set of conditions to retain access to digital media content already listened to and to gain access to new digital media content, without the consumer having to manually download or install new software or in some other manner interact in a manner that will lessen the chance of the consumer embracing or accepting the migration.

So, for example, if continued access to an on-line music library is contingent on the consumer using a particular new version of a browser, then the user is told that he can continue to access the library for say 21 days with his current browser, but that the new version of the browser will auto-install at the end of that period. Similarly, if continued access to an on-line music library is contingent on the consumer using a particular new version of a media player, then the user is told that he can continue to access the library for say 21 days with his current version of the media player, but that the new version of the media player will auto-install at the end of that period.

Likewise with any other condition of access, such as security settings, cookie access, payment tariff levels, and so forth.

By making the imposition of a changed condition an automatic, background or low-profile event, occurring at a time the user has been informed of well in advance, the user much more readily accepts the imposed migration.

Migration can have many benefits—for example, if a specific version of a media player is found to be buggy, or have security issues, then being able to impose an upgrade to a new version across certain or indeed all users over a defined time period, but in a way that meets with broad user acceptance, is very useful.

### SUMMARY OF THE INVENTION

The present invention is a method for providing a user with access to a digital media catalogue while defining and enforcing a time, agreed with the user substantially in advance, at which the conditions under which the user accesses that catalogue may subsequently be modified automatically.

The change(s) made to the conditions of access are made without preventing the user from accessing previously acquired digital media items, even where those items are protected by a DRM (Digital Rights Management) mechanism, without removing the user's access to the digital media catalogue and without requiring that the user manually migrate to the new conditions when the changeover time is reached.

### DESCRIPTION OF THE DRAWINGS

The invention will be described with reference to

FIG. 1, which shows the User lifecycle timeline of an implementation of the invention and

FIG. 2, which shows the process flow for enforcing Use Limits on Condition Sets in the implementation.

### DETAILED DESCRIPTION

An implementation of the invention will be now be described.

Definitions

For convenience, and to avoid needless repetition, the terms “music” and “media content” in this document are to be taken to encompass all “media content” which is in digital form or which it is possible to convert to digital form—including but not limited to books, magazines, newspapers and other periodicals, video in the form of digital video, motion pictures, television shows (as series, as seasons and as individual episodes), computer games and other interactive media, images (photographic or otherwise) and music.

Similarly, the term “track” indicates a specific item of media content, whether that be a song, a television show, an eBook or portion thereof, a computer game or any other discreet item of media content.

The terms “playlist” and “album” are used interchangeably to indicate collections of “tracks” which have been conjoined together such that they may be treated as a single entity for the purposes of analysis or recommendation.

The terms “digital media catalogue”, “digital music catalogue”, “media catalogue” and “catalogue” are used interchangeably to indicate a collection of tracks and/or albums to which a user may be allowed access for listening purposes.

The abbreviation “DRM” is used to refer to a “Digital Rights Management” system or mechanism used to grant access rights to a digital media file.

The verb “to listen” is to be taken as encompassing any interaction between a human and media content, whether that be listening to audio content, watching video or image content, reading books or other textual content, playing a computer game, interacting with interactive media content or some combination of such activities.

The terms “user”, “consumer”, “end user” and “individual” are used interchangeably to refer to the person, or group of people, whose media content “listening” preferences are analysed and for whom recommendations are made. In all cases, the masculine includes the feminine and vice versa.

The terms “device” and “media player” are used interchangeably to refer to any computational device which is capable of playing digital media content, including but not limited to MP3 players, television sets, home computer systems, mobile computing devices, games consoles, handheld games consoles, vehicular-based media players or any other applicable device or software media player on such a device.

1. Registration

A user is granted access on a subscription basis to a digital media catalogue via his connected device by registering with the service which provides access to that catalogue.

The said service provides at least two alternative sets of conditions for accessing the service. The first set, Cond A, consists of the service's standard conditions for access to the catalogue. The second set, Cond B, is a different set of conditions which also provides access to the catalogue.

When registering with the service using Cond B, the user is informed of the Conditions Set for both Cond A and Cond B, including the condition that the user will be migrated to Cond A at a pre-defined point, and is required to agree to both in order to access the service using the Cond B condition set.

Having agreed, the user accesses the service under the Cond B conditions until the user reaches the end of the Applicable Time Period (see below) for those conditions, at which point the user is automatically switched to the “next condition set” defined for Cond B.

2. Defining A Condition Set

In one example embodiment, multiple conditions are employed on the service. In the description below, the term Cond B is used for simplicity, but is to be interpreted as referring to any alternative set of conditions on the service.

Similarly, the term Cond A is used for simplicity, to refer to the set of conditions to which the user is switched after using Cond B. In the preferred embodiment, there may be multiple Cond A sets, each providing the user with different conditions of access to the catalogue and each with one or more associated Cond Bs.

Each Conditions Set has an associated Access Time Period, which defines the period of time during which the user is provided access to the catalogue. That time period may be defined as a specified number of calendar months, days or weeks or by specifying a date and/or time at which the user is required to renew his subscription on order to continue to have access to the catalogue. Such renewal happens automatically, with the prior agreement of the user, and without a change to the Conditions Set used, until the end of the Applicable Time Period (see below) for that Conditions Set.

Each Conditions Set usable on the service has an associated set of metadata which defines the conditions for that set, with the requirement that the user agrees to all defined conditions for a given Conditions Set as a pre-condition for being permitted to access the service using that Conditions Set.

All Conditions Sets which will migrate the user to a different Conditions Set (i.e. all Cond B sets) define, in addition to the metadata defining the precise conditions which they impose on access to the service, the following:
An Applicable Time Period, during which the user is permitted access using Cond B before being automatically switched to Cond A. The Applicable Time Period may be defined similarly to the time period defined above, though its duration may differ.
A Next Conditions Set value, which defines which Conditions Set the user is to be switched to at the end of the Applicable Time Period for Cond B.
A Use Limit value, which defines the number of times that a given uniquely identifiable user is permitted to make use of Cond B. Having used Cond B the Use Limit number of times, the user will no longer be permitted to register with the service using the Cond B Conditions Set but is instead directed to another Conditions Set, such as Cond A. In the preferred embodiment, the Use Limit is defined as 1 (one).

For example, suppose that Cond A consists of a subscription tariff of $5 per calendar month and that Cond B is defined as $1 per calendar month, may be used once only per user and is valid for 3 calendar months before switching to Cond A.

In that example scenario, the Access Time Period for both Conditions Sets is “1 calendar month”; the Applicable Time Period for Cond B is “3 calendar months”; the Use Limit for Cond B is 1; the Next Conditions Set for Cond B is Cond A and each of those Conditions Sets has associated metadata defining a “monthly subscription charge amount” for Cond A and Cond B as “$5” and “$1” respectively.

The user who subscribes to the service under the Cond B set agrees to the Conditions Set defined for that set. Specifically, in this example scenario, the user must agree that a monthly subscription is required of $1 per calendar month [subscription metadata plus Access Time Period for Cond B] for 3 calendar months [Applicable Time Period for Cond B], after which the subscription charge will change to $5 per calendar month [subscription metadata plus Access Time Period for Cond A].

If the conditions metadata for the two Condition Sets in the example scenario above were to define a change of media player—such as Cond B providing access using the WinAmp™ player and Cond A requiring a migration to Window Media Player™ version 11—then the action actually undertaken by the system at the time of changeover would be to migrate the user to the new media player but all other activities undertaken in the scenario would be the same, with the initial agreement made by the user on subscribing under the Cond B Condition Set reflecting the metadata conditions defined.

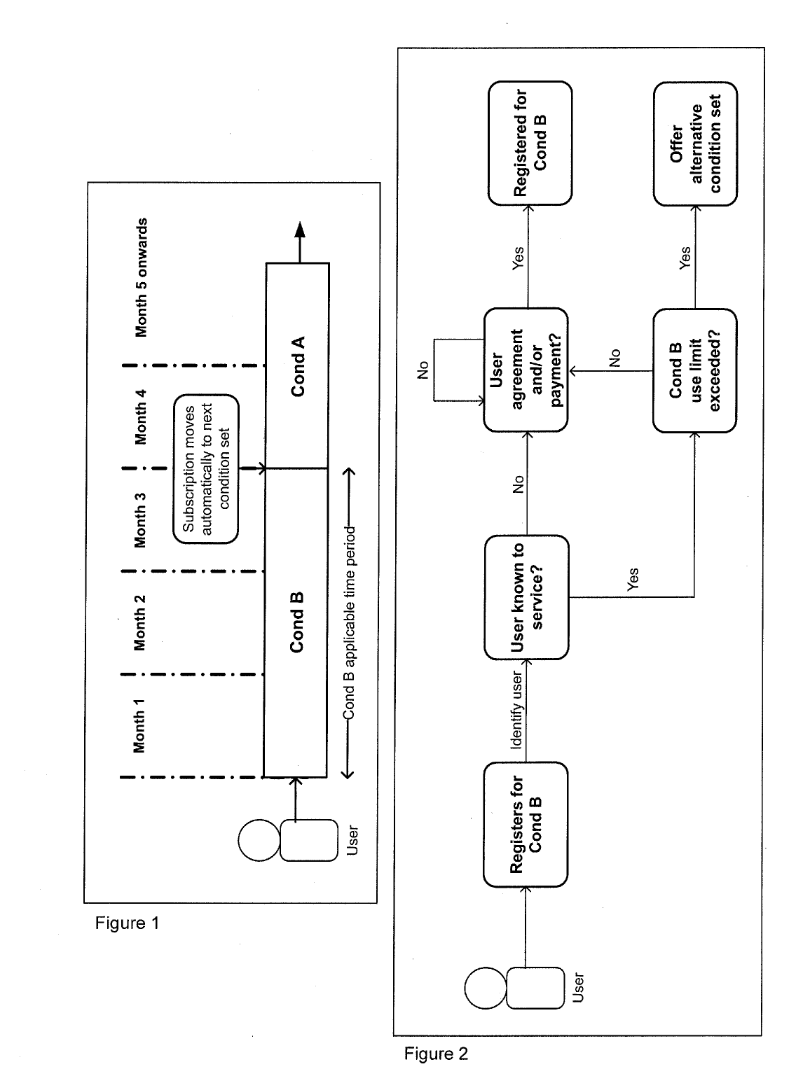

FIG. 1 illustrates the timeline in the preferred embodiment for a user who starts using the service using Cond B and who is then switched, after the Applicable Time Period for Cond B, to use Cond A.

3. Enforcing the Use Limit

To ensure that users are permitted to make use of Cond B only the prescribed number of times (that condition set's associated Use Limit), the sign-up process for the said Conditions Set requires that the user be uniquely identified to the service.

The user's identification may be made using any details defined as uniquely identifying a user, such as a credit card, a confirmed home address, an email address, a device identifier, bank account details or some other mechanism or combination of mechanisms.

The user may also be required to pay a charge in order to subscribe using Cond B. In one example embodiment, the uniquely identifying details and the payment method are the same mechanism, a non-comprehensive list of such mechanisms being a credit card, a debit card, a digital wallet uniquely identifying that user, a voucher purchased by that user using such a uniquely identifiable method, a payment mechanism linked to the user's mobile phone or some other uniquely identifiable method of payment.

When a user attempts to use a Conditions Set, that user's uniquely identifying details are checked against a list of previous users of that Conditions Set and, if that user is identified as having utilised that Conditions Set the maximum number of times (the Use Limit) then he is refused access to that Conditions Set and, in the preferred embodiment, is directed to a different Conditions Set, such as the Next Conditions Set defined for the Conditions Set which the user attempted to utilise. This process is illustrated in FIG. 2.

In the preferred embodiment, Use Limits exist both for individual Condition Sets, for groups of Condition Sets and for the service as a whole. Thus, a Use Limit restriction may be encountered if a user attempts to utilise Cond C having previously used the Cond B set.

4. Digital Rights Management

When users are allowed access to the digital media catalogue of a service, the media files provided to that user may be protected using one or more Digital Rights Management (DRM) mechanisms. The choice of mechanism is determined by a number of factors, such as the device type, the file format, the range of rights permissions provided by a specific mechanism, the encoding quality of the DRM algorithm, the file size of the DRM-encrypted files, and other applicable factors.

When a user switches Condition Set, as described above, some DRM mechanisms can require that the change to the user's status requires a change to the user's access rights both to digital media files on the service and to digital media files which that user has previously downloaded from the service. Such a change would render the user's digital media collection inaccessible and would therefore necessitate that the user re-download all previously-downloaded digital media files.

In such a circumstance, the present invention, in its preferred embodiment, automatically updates the user's DRM license, in the form of the root authorisation certificate or rights object provided to the client device from the service's DRM server, such that the user retains access to his previously-downloaded digital media files and that, therefore, the user's change of conditions of access to the service (the change of Condition Set) does not interrupt his listening to his media content files.

Whether a given digital media file is DRM-protected or not then control of access to that file is instead—or in addition in the case of media files which are DRM-protected—managed at the service level.

In another example embodiment of the present invention, track download and acquisition access may be controlled by the service's content server based on the entitlement rights granted by virtue of that customer's subscription to the service. In that embodiment, the present invention automatically adjusts the user's access rights on the content server, where necessary, to allow the user to continue to acquire new digital media content and/or to access his previously-downloaded content when the change of Condition Set takes place. The client-side device implements the same access logic based on directions received from the server when the user's Condition Set changes.

5. Offline Operation

When a Condition Set change is scheduled but the user's device is not connected to the service via the network then in the preferred embodiment the user is permitted to continue to access his previously-downloaded media content files and the Condition Set will be changed automatically by the service. Any server-side actions required by the change of Condition Set, such as a change of subscription rate or a modification of access rights granted or user-benefits provided by the differing Condition Sets, are performed automatically by the server.

On reconnection, the service communicates with the client device to ensure that the said device is migrated to the new Condition Set, such as migrating the client device to a new media player or modifying the DRM root certificates or rights objects as disclosed above, and to check that the client is able to continue accessing the service based on the access rights granted by virtue of the user's new Condition Set following the change, using the mechanisms disclosed above.

6. Pre-Existing Users of the Service

Pre-existing users of the service may be offered access to an alternative Condition Set, such as a user on Cond A being offered Cond B on the same or similar terms as those offered to new subscribers to the service. In such a case, the pre-existing user will, in the preferred embodiment, be able to utilise Cond B in the same manner as a newly registered user, and with the same conditions applied, as defined above, including the application of time periods.

7. Cancellation

In the preferred embodiment, users are permitted to cancel their subscription to the service at any time, regardless of which Condition Set the user is making use of at that time, though individual Condition Sets may apply cancellation terms such as a minimum length of subscription.

8. Linking Specific User Benefits to Condition Sets

Users of some Condition Sets may, in some embodiments, be provided with additional benefits which are not available to users of other Condition Sets on the same service.

In the preferred embodiment, such benefits may include, but are not limited to, the downloading of DRM-free digital media files, access to specific websites or additional content, cross-device linking, access to the user's personalised music library on multiple devices or any other benefits. Access to such benefits is defined in the metadata for the individual Condition Sets, as disclosed above.

9. Tariff Considerations and Business Model Impact

A particular change of Condition Set may result in a modification of the subscription tariff payable by the user. Some such tariffs have a direct impact on the business model employed by the service. Such a business model is outlined in this section.

One example implementation of the present invention is to provide an initial low subscription tariff to users as an introductory rate which is then, at a pre-defined time agreed with the user, migrated to the standard tariff for the service, as in the illustrative example presented above in FIG. 1. It may be that at that point other additional services may be offered to the consumer, or it may be that the service remains identical.

In order to implement such a business model for a networked service which is based on providing access to a digital music catalogue, the business model requirements would be that music publishers and/or collection societies be paid in full, based on the relevant statutory rates or published tariffs, and that music labels enter into a negotiated licensing agreement to receive royalties on a pro-rata to consumer behaviour basis, a per-minima basis or a fixed basis during that introductory period.

With the correct level of pricing selected for the initial period the statutory rates relating to publishing could be paid in full to the publishers and collection societies based on the consumer payment, meaning the business model requirement would only be that the music labels enter into explicit agreements for each such territory, with the vast number of major publishers and collection societies simply being paid statutory rates.

That model therefore enables the business to expand in terms of reach and territory very rapidly (with a small number of negotiated agreements with labels but a very large number of statutory agreements with major publishers which are simple to obtain) and also to provide additional incentives, such as introductory or time-limited reduced tariff offers or any other offers enabled by the technology in the present invention, to encourage new users to register and sign up to the service.

Key Concepts

The key concepts implemented in this invention include the following:
1. A method for automatically changing the conditions under which an end-user may access a service by (a) defining a Condition Set of access conditions which include zero, one or more steps in which the end user is automatically migrated to another Condition Set; (b) obtaining user consent to the set of access conditions in (a); and (c) automatically enforcing the access conditions defined in the Condition Set in (a).
   the Condition Set comprises one or more of an Applicable Time Period, an Access Time Period, a Use Limit, a Next Condition Set indicator and any additional metadata associated with the service or with the purpose to which the Condition Set is being put.
   the Use Limit defines the number of times that a uniquely identified end-user is permitted to make use of the associated Condition Set.
   the Applicable Time Period defines the period of time during which the end-user is permitted to make use of the associated Condition Set.
   the Access Time Period defines the period of time during which the end-user is permitted to access the digital media content while the associated Condition Set is in use by that end-user.
   the Next Condition Set indicator specifies the Condition Set to which an end-user is to be migrated at the end of the Applicable Time Period for the associated Condition Set.
   the “uniquely identified end-user” is uniquely identified on the system by any reasonable means, including but not limited to the provision of uniquely identifying payment details such as a credit or debit card, a confirmed home address, an email address, a device identifier, bank account details, a payment method linked to a device which is linked to that user, the provision of any other recognized identification data, by means of biometrical identification, a voucher obtained using a uniquely identifiable method or by any combination of such methods.
   the migration from one Condition Set to another happens automatically, semi-automatically or manually.
   the associated service is a catalogue of digital media content or any other applicable service.
   the purpose to which the Condition Set is being put is the management of subscriptions and the associated metadata includes, but is not limited to, zero, one or more of the subscription tariff and metadata defining any additional benefits associated with that subscription.
   the digital media content comprises music, video, movies, television programmes, computer games, eBooks, periodicals, magazines, articles or any other digital media content
   the digital media content is protected or encrypted using any Digital Rights Management (DRM) mechanism.
   the migration of the end-user from one Condition Set to another requires the migration of the user's previously accessed digital media content from one DRM system to another, the adjustment or replacement of the user's access rights or root Rights Object for the associated service or some combination thereof.
   the migration of DRM or access rights happens automatically.
   the service associated with a given Condition Set is accessed via a network or is installed on a computing device including, but not limited to, a desktop computer, a laptop computer, a mobile device, a games console or any other computing.
   a condition set can define any one or more of the following: capabilities, parameters, functionality, versions of computer software.
   a condition set can define any one or more of the following: access requirements for digital media content; parameters for access requirements for digital media content.
   there can be multiple condition sets in addition to the first and second condition sets.

1. A method of accessing digital media content using a computing device in which a user accesses that digital media content with a first condition set applied to the operation of the computing device; in which the user's computing device is, after a predetermined time period or use limit has expired, automatically migrated to accessing digital media content with a second condition set applied to the operation of the computing device.

2. The method of claim 1 in which the user consents to the migration to the second condition set, but substantially in advance of the process of migrating to the second condition set.

3. The method of claim 1 in which the user consents to the migration to the second condition set, but not as part of the process of migrating to the second condition set.

4. The method of claim 1 in which the user does not manually select an option to use or migrate to the second condition set at substantially the same time or as part of the same process as migrating to the second condition set.

5. The method of claim 1 in which the user retains access to previously accessed digital media content.

6. The method of claim 1 in which the user does not manually download or manually install new software in order to migrate to the second condition set.

7. The method of claim 1 in which the first and/or second condition set requires automatic migration to the second condition set after a predefined time period.

8. The method of claim 1 in which the first and/or second condition set requires migration to the second condition set after the user has used the first condition set a predefined number of times.

9. The method of claim 1 in which the first and/or second condition set defines a period of time during which the user is permitted to access the digital media content while the associated condition set is in use by that user.

10. The method of claim 1 in which the first and/or second condition set defines a specific version of a browser.

11. The method of claim 1 in which the first and/or second condition set defines a specific version of a media player.

12. The method of claim 1 in which the first and/or the second condition set defines specific security settings.

13. The method of claim 1 in which the first and/or the second condition set defines specific cookie access.

14. The method of claim 1 in which the first and/or the second condition set defines specific payment tariff levels.

15. The method of claim 1 in which the migration of the end-user from one condition set to another requires the migration of the user's previously accessed digital media content from one DRM system to another, the adjustment or replacement of the user's access rights or root Rights Object for the associated service or some combination thereof.

16. The method of claim 15 in which the migration of DRM or access rights happens automatically.

17. The method of claim 1 in which a user is uniquely identified.

18. The method of claim 17 in which the user is uniquely identified by one or more of: the provision of uniquely identifying payment details such as a credit or debit card, a confirmed home address, an email address, a device identifier, bank account details, a payment method linked to a device which is linked to that user, the provision of any other recognized identification data, by means of biometrical identification, a voucher obtained using a uniquely identifiable method or by any combination of such methods.

19. The method of claim 1 in which a condition set defines any one or more of the following: capabilities, parameters, functionality, versions of computer software.

20. The method of claim 1 in which a condition set defines any one or more of the following: access requirements for digital media content; parameters for access requirements for digital media content.

21. The method of claim 1 in which there are multiple condition sets in addition to the first and second condition sets.

22. (canceled)

23. (canceled)

24. The method of claim 1 in which the automatic migration to the second condition set occurs in background.

25. Computer software implemented on a computing device that enables that device to access digital media content using the method of claim 1.

26. A method for automatically defining, and subsequently changing, the conditions under which an end-user may access a service by (a) defining a Condition Set of access conditions which include zero, one or more steps in which the end user is automatically migrated to another Condition Set; (b) obtaining user consent to the set of access conditions in (a); and (c) automatically enforcing the access conditions defined in the Condition Set in (a).
